(19) United States
(12) Patent Application Publication
(10) Pub. No.: US 2021/0019668 A1
(43) Pub. Date: Jan. 21, 2021

(54) FIXED-ROUTE AND ON-DEMAND TRANSPORTATION ASSET OPTIMIZATION

(71) Applicant: Tripshot, Inc., San Jose, CA (US)

(72) Inventors: Wayne Lewis, Beaverton, OR (US); Patrick Le, San Jose, CA (US); Philip Weaver, Beaverton, OR (US)

(21) Appl. No.: 16/515,002

(22) Filed: Jul. 17, 2019

(51) Int. Cl. G06Q 10/02; G06Q 50/30; G06Q 10/06; G08G 1/00

(52) U.S. Cl. CPC G06Q 10/02; G08G 1/202; G06Q 10/06315; G06Q 50/30

(57) ABSTRACT

Methods and systems for fulfilling an on-demand service request are provided. Exemplary methods include: receiving an on-demand service request; getting a pool of transportation assets; removing at least one transportation asset from the pool of transportation assets; ranking the transportation assets in the pool of transportation assets using weighted cost criteria; selecting a second transportation asset from the pool of transportation assets using the ranking; dispatching the second transportation asset to fulfill the on-demand service request; determining that the second transportation asset will be late for the variable pick-up time based on location information received from the second transportation asset; selecting a third transportation asset from the pool of transportation assets using the ranking; and dispatching the third transportation asset to fulfill the on-demand service request.

### FIELD OF THE INVENTION

The present technology pertains to transportation, and more specifically to transportation asset optimization.

### BACKGROUND ART

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A vehicle fleet is a group of motor vehicles owned or leased by a business, government agency, or other organization rather than by an individual or family.

### SUMMARY OF THE INVENTION

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to various methods and systems for fulfilling an on-demand service request. Specifically, a method for fulfilling an on-demand service request may comprise: receiving an on-demand service request, the on-demand service request including at least one of a variable pick-up time, variable pick-up location, variable drop-off location, and variable drop-off time; getting a pool of transportation assets, the transportation assets including at least one of a bus, van, minivan, and car; removing at least one transportation asset from the pool of transportation assets, the removing the at least one transportation asset including: withdrawing a first transportation asset from the pool of transportation assets when a delay to a scheduled pick-up time for a fixed-route service will exceed a predetermined threshold, the delay arising from using the first transportation asset, the fixed-route service including predefined pick-up and drop-off locations; ranking the transportation assets in the pool of transportation assets using cost criteria, the cost criteria including at least one of depreciation, fuel cost, driver time, and government fees; selecting a second transportation asset from the pool of transportation assets using the ranking; dispatching the second transportation asset to fulfill the on-demand service request; determining that the second transportation asset will be late for the variable pick-up time of the on-demand service request based on location information received from the second transportation asset; selecting a third transportation asset from the pool of transportation assets using the ranking; and dispatching the third transportation asset to fulfill the on-demand service request.

### BRIEF DESCRIPTION OF THE DRAWINGS

Embodiments are illustrated by way of example, and not by limitation, in the figures of the accompanying drawings, in which like references indicate similar elements and in which:

FIG. 1 is a simplified block diagram of a map, according to some embodiments.

FIG. 2 is a block diagram of a system for transportation asset optimization, according to various embodiments.

FIG. 3 is a simplified block diagram of a mobile device, in accordance with some embodiments.

FIG. 4 is a simplified flow diagram of a method for fulfilling an on-demand service request, in accordance with various embodiments.

FIG. 5 is a simplified block diagram of a computing system, according to some embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

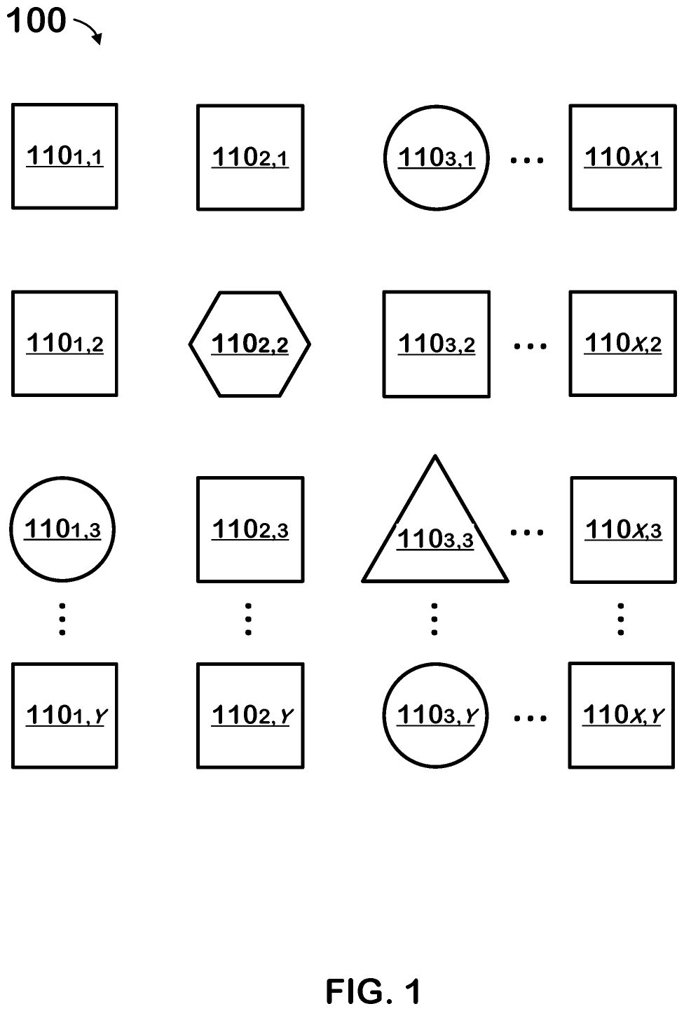

FIG. 1 shows map 100, according to some embodiments. Map 100 can be a simplified representation of a geographic region. The geographic region of map 100 can span cities, counties, states, countries, and the like. Map 100 can include locations 110_{1,1}-110_{X,Y}. Locations 110_{1,1}-110_{X,Y} can be a structure, region, or other feature in the geographic region of map 100. For example, locations 110_{1,1}-110_{X,Y} can be a residence, such as a house, townhome, condominium, and apartment. By way of further example, locations 110_{1,1}-110_{X,Y} can be a business, such as a shop, store, restaurant, motel, hotel, gas station, warehouse, office building, and the like. By way of further example, locations 110_{1,1}-110_{X,Y} can be another site, such as a street corner, bus stop, park, amusement park, train station, bus terminal, airport, monument, other landmark, and the like.

Typically, some of locations 110_{1,1}-110_{X,Y} are predefined by the operator of a transportation service (also known as transportation service operator or simply operator). Transportation service operators can include (business) organizations whose primary business is something other than transportation and the transportation service is offered, for example, to attract and retain employees. For example, Apple Inc., Facebook, Inc., Google LLC, and the like each operate and maintain large fleets of busses to transport their employees to their corporate campuses. The operator provides transportation to and from various locations of locations 110_{1,1}-110_{X,Y}. By way of non-limiting example, the operator can provide transportation to and from location 110_{1,Y} (and/or other locations of locations 110_{1,1}-110_{X,Y}) and location 110_{3,3}.

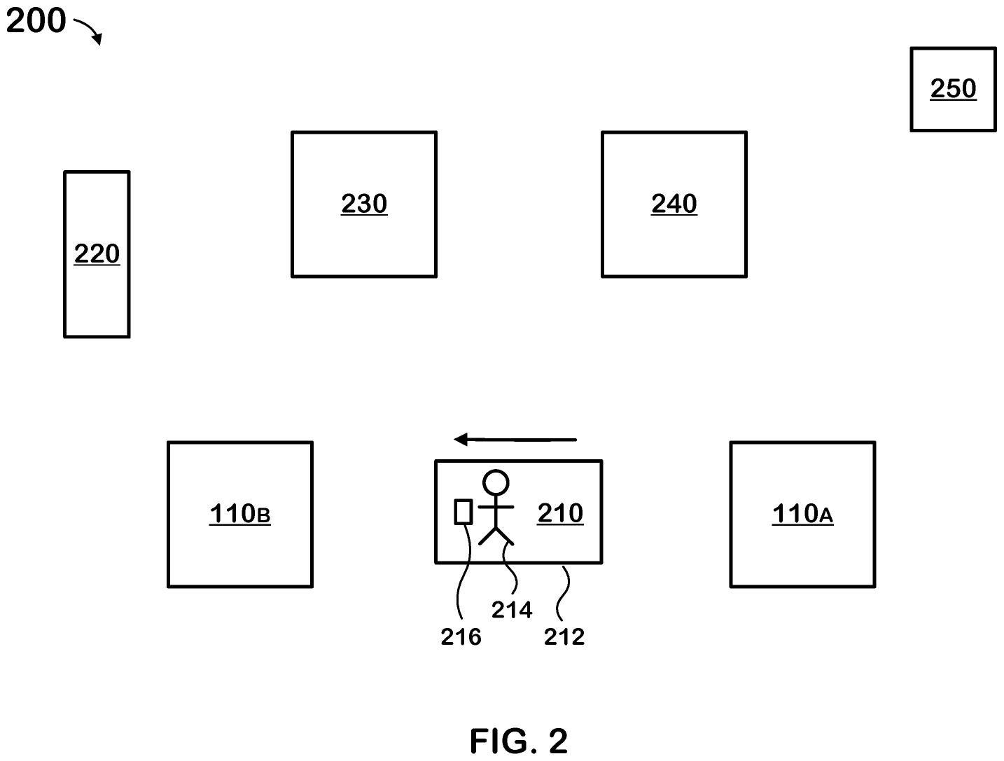

In some embodiments, operators can specify locations where passengers (also referred to as riders and/or users) can be picked up and dropped off, which can be referred to as predetermined or predefined locations. For example, locations 110_{1,1}, 110_{1,2}, 110_{1,Y}, 110_{2,1}, 110_{2,3}, 110_{2,Y}, 110_{3,2}, 110_{X,Y}-110_{X,Y}, and 110_{3,3} are sites specified by an operator for pick up and drop off of passengers. By way of further non-limiting example, location 110_{3,3} can further be a corporate campus where passengers are picked up and dropped off. When a corporate campus includes buildings (and/or clusters of buildings) spread out across a large area, there can be multiple of location 110_{3,3}. Typically, the corporate campus and the transportation service are associated with (e.g., controlled or operated by) the same (business) organization or company. By way of additional non-limiting example, location 110_{2,2} is a yard where transportation assets (associated with the operator) are stored and maintained. Transportation assets are described further in relation to FIG. 2.

Typically, locations specified by the operator (e.g., locations 110_{1,1}, 110_{1,2} , 110_{1,Y}, 110_{2,1}, 110_{2,3}, 110_{2,Y}, 110_{3,2}, 110_{X,1}-110_{X,Y}, and 110_{3,3}) do not change and are served by transportation assets according to a (regular) schedule (e.g., pick up and/or drop off times, by day of the work week, weekends, holidays, etc.). The (regular) schedule generally does not change (e.g., it is in effect for weeks, months, years, etc.). The (regular) schedule can be referred to as predetermined or predefined, since it can be established (day, weeks, months, etc.) before a scheduled service is actually provided. Transportation service provided to predetermined locations according to a schedule can be referred to as a fixed-route service.

In contrast to fixed-route service, on-demand service is not performed according to a (regular) schedule and is instead provided whenever it is requested. According to various embodiments, an on-demand service can be requested in advance (e.g., a reservation is made), but still differs from fixed-route service in that the on-demand service is provided according to a reservation (which can be canceled), instead consistently repeating according to a (regular) schedule. Additionally or alternatively, on-demand service can be provided to a location specified by the operator, a geofence (virtual geographic boundary) around a location specified by the operator, and/or a location not specified by the operator (and instead is a variable location specified by the requestor/passenger).

Locations 110_{1,1}-110_{X,Y} can be identified/specified by a street address, Global Positioning System (GPS) coordinates (e.g., latitude and longitude; degrees/minutes/seconds; etc.), and the like. A geofence can be specified by a circle and/or polygon using a location. In the case of a circle, the geofence can be further specified by a radius extending outward from the location. In the case of a polygon, the geofence can be further specified by the length of a side of the polygon. Alternatively or additionally, the polygonal geofence can be further specified by at least one vertex of the polygon. Locations 110_{1,1}-110_{X,Y} can be connected to each other through a network of roads, toll roads, streets, freeways, highways, bridges, and the like (not depicted in FIG. 1). Although locations 110_{1,1}-110_{X,Y} are shown as being evenly distributed in map 100, locations 110_{1,1}-110_{X,Y} can be spread unevenly (naturally) across the geographic region of map 100.

FIG. 2 depicts a system 200 for transportation asset optimization. System 220 can include location 110_{A}, location 110_{B}, transportation asset 210 (also known as asset), cell site 220, data center 230, dispatch 240, and GPS satellite 250. Location 110_{A} and location 110_{B} can have at least some of the characteristics of location 110_{1,1}-110_{X,Y} (FIG. 1). Asset 210 can include vehicle 212, driver/operator 214, and mobile device 216. Reference to asset 210 can be to various combinations of vehicle 212, driver/operator 214, and mobile device 216.

Vehicle 212 can be a bus, van, mini-van, car, sport utility vehicle, truck, and the like. Vehicle 212 can run on fuel, such as diesel, gasoline, compressed natural gas (CNG), hydrogen fuel cell, electricity, hybrid gasoline-electricity, and the like. Vehicle 212 can be a self-driving vehicle (e.g., car, minivan, van, sport utility vehicle, truck, and the like) (also referred to as an autonomous vehicle, robot vehicle, driverless vehicle, and the like), according to some embodiments. A self-driving vehicle can be a vehicle that is capable of sensing its environment and moving with little or no human input (e.g., SAE automation level 3, 4, and/or 5). When vehicle 212 is a self-driving car, driver 214 is optional. Driver 214 can be the human operator of vehicle 212. Mobile device 216 can be a smartphone, phablet, tablet computer, and the like. Mobile device 216 can have wireless Internet access, such as services using 3G, 4G, 5G, etc. wireless mobile telecommunications technology.

Cell site 220 (also referred to as a cell tower, cellular base station, etc.) can be a cellular-enabled mobile device site where antennae and electronic communications equipment are placed—typically on a radio mast, tower, or other raised structure—to create a cell (or adjacent cells) in a cellular network. Typically, cell site 220 is used to provision wireless Internet service. Data center 230 can be a facility that houses computing facilities like servers, routers, switches and firewalls, as well as supporting components like backup equipment, fire suppression facilities, and air conditioning. Data center 230 can be run by the operator of a transportation service, rented/leased (e.g., a cloud computing environment) by the operator of a transportation service, etc. Data center 230 can receive real-time information from mobile device 216 (e.g., location) using various combinations of wired (e.g., broadband Internet service such as cable, DSL, and the like) and wireless (e.g., Bluetooth, Wi-Fi, wireless Internet access, and the like) communications.

Dispatch 240 can be a facility run by the operator of the transportation service to monitor and allocate transportation services. Dispatch 240 can include personnel, equipment, a building to house them, and the like. Dispatch 240 can send and/or receive data from data center 230 over various combinations of wired and wireless communications. Although shown as distinct entities, data center 230 and dispatch 240 can be integrated into one facility.

For illustrative purposes (and not limitation), transportation asset 210 is travelling from location 110_{A} to location 110_{B}. As transportation asset 210 travels from location 110_{A} to location 110_{B}, the present location (between location 110_{A} and location 110_{B}) of transportation asset 210 can be (continuously) determined by mobile device 216 using a GPS signal from GPS satellite 250. Mobile device 216 can (continuously) transmit its present location through cell site 220 to data center 230. For example, mobile device 216 determines a location of transportation asset 210 in a range from every 0.1 seconds to every 30 seconds. By way of further non-limiting example, mobile device 216 sends location information data center 230 in a range from every 0.1 seconds to every 30 seconds. Data center 230 can store and provide information gathered from multiple of transportation asset 210 to dispatch 240.

Fixed-route service can be predictable. A pool of known transportation assets 210 provide service (e.g., pick up passengers, travel routes, and drop off passengers) according to a predetermined (regular) schedule. In contrast, on-demand service can be unpredictable and more flexible. A pool of known transportation assets 210—which are otherwise not committed to providing fixed-route service—can provide service on an irregular basis as needed. Provisioning an on-demand service from a pool of transportation assets—some of which are also committed to a fixed-route service—is a non-trivial challenge.

A vehicle fleet can include multiple of transportation asset 210, all of which are controlled by a transportation service operator. The composition of the vehicle fleet is (for the most part) predictable, since any changes (e.g., adding or removing an asset) usually occur infrequently (e.g., given the high capital costs of a transportation asset and personnel costs of the driver). Since the vehicle fleet is controlled by the operator, any and all transportation assets (e.g., multiple of transportation assets 210) can be deployed as directed. In contrast, ride hailing services—ride hailing services are services that use online-enabled platforms to connect between passengers and local drivers using their personal vehicles—have continually changing set of available vehicles, any of which can decline to an assignment. Examples of ride hailing services include Lyft, Inc. and Uber Technologies Inc.

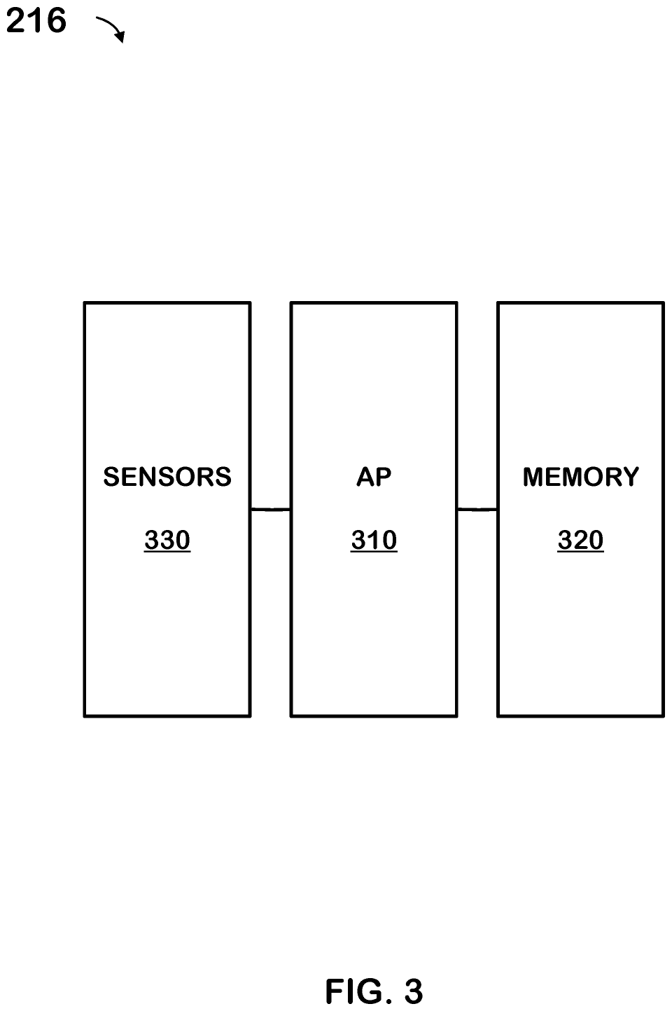

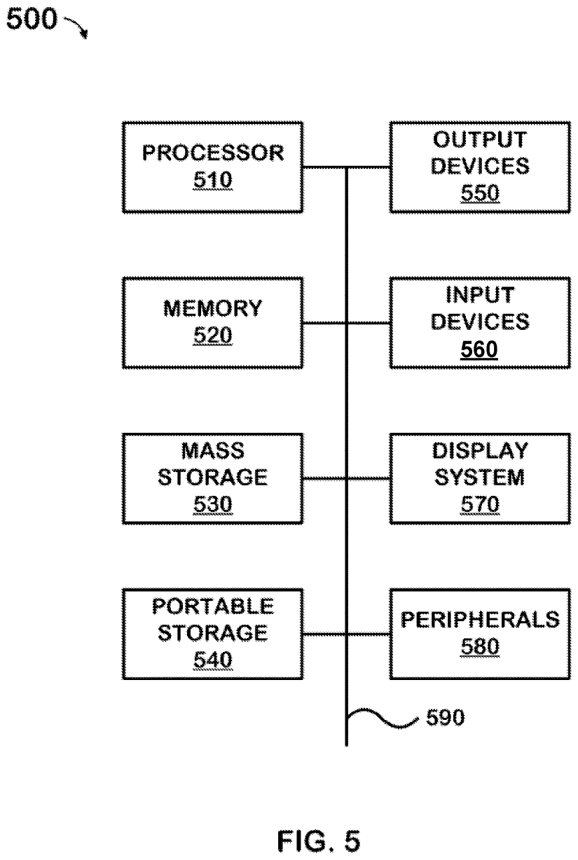

FIG. 3 illustrates mobile device 216, according to some embodiments. Mobile device 216 can include application processor 310, memory 320, and sensors 330. Application processor 310 is an integrated circuit (IC) (also known as a “chip”) used for primary application processing, in contrast with the ICs that handle functions such as the display, wireless communications, and power management. For example, application processor 310 is a system on a chip (SoC), which is an integrated circuit that integrates multiple components of a computer. Such components can include multiple processor (typically ARM) cores, graphics processing units (GPUs), cache memories, memory controllers (e.g., for communicating with memory 320), audio and video encoders/decoders, USB host controllers, and the like. Processors generally are described in relation to FIG. 5.

Sensors 330 can include a Global Positioning System (GPS) receiver, accelerometer, gyroscope, magnetometer, proximity sensor, ambient light sensor, microphone, and the like. A GPS receiver can receive information from GPS satellites (e.g., GPS satellite 250 in FIG. 2) which can be used to calculate the mobile device's (e.g., mobile device 216) geographical position. When mobile device 216 is in or on vehicle 212, the location of mobile device 216 is the same as the location of vehicle 212 (and coll. Sensors 330 can further include one or more radios for wireless Internet (high-speed data), Bluetooth, Wi-Fi, near-field communications (e.g., for reading radio-frequency identification (RFID) tags), and the like.

Memory 320 can be volatile (e.g., dynamic random-access memory (DRAM) and/or static random-access memory (SRAM)), non-volatile (e.g., flash memory), and combinations thereof. Memory 320 can store information for use by application processor 310. In some embodiments, memory 320 stores a mobile operating system and application, and application processor 310 executes/runs the mobile operating system and application.

A mobile operating system is system software that manages hardware and software resources and provides common services for programs (applications). The mobile operating system 310 can combine features of a personal computer operating system with other features useful for mobile, such as a wireless inbuilt modem and SIM tray for telephony and data connection, a touchscreen, cellular, Bluetooth, Wi-Fi Protected Access, Wi-Fi, Global Positioning System (GPS) mobile navigation, video- and single-frame picture cameras, speech recognition, voice recorder, music player, near field communication, and the like. For example, the mobile operating system is Apple iOS and/or Google Android.

An application is software designed to perform a group of coordinated functions, tasks, or activities. In some embodiments, the application monitors and (continuously) reports the present location of a vehicle (e.g., vehicle 212 in FIG. 2) to a dispatcher (e.g., dispatch 240) through a data center (e.g., data center 230), among other features. Memory 320 is described further in relation to FIG. 5. Mobile device 216 can include more or fewer resources, such as those described in relation to FIG. 5.

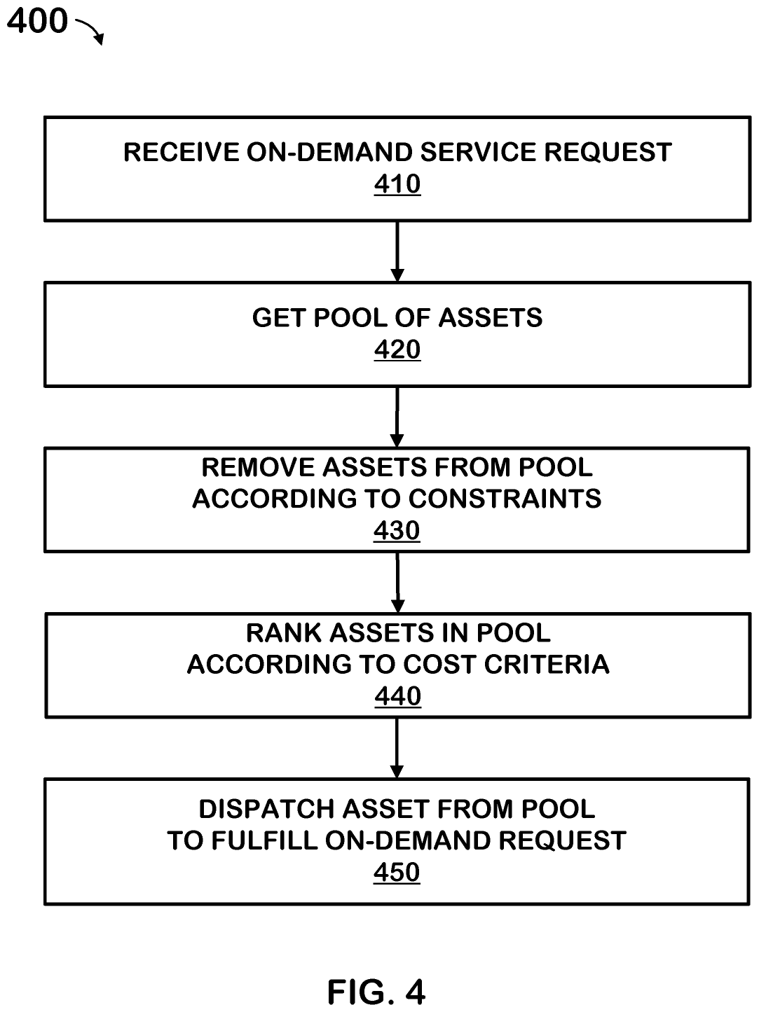

FIG. 4 shows method 400 for provisioning an on-demand service, according to some embodiments. Method 400 can be performed by data center 230 and/or dispatch 240 (FIG. 2). Method 400 can commence at step 410 where an on-demand service request is received. The on-demand service request can include a variable time for pick up (e.g., not limited to a predetermined schedule), a variable pick-up4 location (e.g., not limited to a predefined location), variable drop-off location (e.g., not limited to a predefined location), variable time for drop off (e.g., not limited to a predetermined schedule), additional instructions (e.g., wheelchair access), and the like. The on-demand service request can be made temporally close (e.g., only hours or even minutes before) to the requested pick-up time. The on-demand service request can be made with advance notice (e.g., at least 24 hours before the requested pick-up time).

At step 420, a pool of transportation assets (e.g., multiple of transportation asset 210 in FIG. 2) can be collected. In some embodiments, transportation assets can be omitted from the pool due to being out of service caused by scheduled maintenance, mechanical issue flagged by the driver, expired insurance policy, expired registration, and the like.

At step 430, transportation assets from the pool of assets can be removed according to one or more constraints. In some embodiments, data center 230 and/or dispatch 240 (FIG. 2) can identify transportation assets that are not already committed to providing a scheduled fixed-route service (e.g., can range from being absolute such that no scheduling overlap is allowed, to a permitting some scheduling overlap such that the predicted delay on the fixed-route schedule is limited to a predetermined amount of time (e.g., 5-25 minutes late for scheduled pick up)). According to various embodiments, a passenger on a fixed-route service can influence the predetermined amount of delay he or she will experience. For example, each passenger on the fixed-route service can be classified. Passengers classified as regular/normal can be subject to a higher predetermined delay. In contrast, passengers classified as a very important person (VIP) may be subject to a lower predetermined delay. Passengers on the fixed-route service (and hence their classification) can be identified by reservation, badge, digital ticket (e.g., application on a smartphone can display a QR code or communicate with mobile device 216 (FIG. 2) using Bluetooth), radio-frequency identification (RFID) tags, and the like.

Additionally or alternatively, an asset can be removed from the pool, when the driver (associated with the asset) exceeds a limit on working hours (e.g., to limit overtime pay). For example, when driver 214 (FIG. 2) works from 9:00 AM to 5:00 PM and an on-demand service would not be completed until after 5:00 PM, then the asset associated with this driver will be removed from the pool.

Additionally or alternatively, an asset can be removed from the pool, when the asset may run out of fuel. For example, electricity and compressed natural gas powered vehicles can travel a shorter distance before refueling than gasoline- and/or diesel-powered cars. The number of vehicle mile remaining/available for a (electric and/or natural gas powered) vehicle can be considered when optimizing a schedule for the vehicle. Additionally or alternatively, future schedules and/or charging/refueling times that put a vehicle out of service can be considered when optimizing a schedule for the vehicle. An asset can be removed from the pool when the asset can run out of fuel (and become stranded). The asset running out of fuel can be predicted/estimated based on a starting amount of fuel in the asset (e.g., full charge or tank at the start of the day), and distance traveled, amount of time spent idling, and the like from mobile device 216 (FIG. 2).

Additionally or alternatively, an asset can be removed from the pool, when the asset does not have a license or certification needed to fulfill the on-demand service. For example, driver 214 may not have a first-aid certification needed to transport certain passengers. By way of further non-limiting example, vehicle 212 may not have equipment needed to accommodate certain passengers, such as a lift, ramp, securement device (e.g., straps for securing wheelchairs on board, child safety seat (e.g., infant carrier, child booster seat, etc.)), signage, and the like.

Additionally or alternatively, an asset can be removed from the pool, when the asset does not have equipment needed to fulfill the on-demand service. For example, vehicle 212 may not have a lavatory needed when travelling long distances.

Additionally or alternatively, an asset can be removed from the pool, when the asset does not have a local certification/license needed to fulfill the on-demand service. For example, vehicle 212 does not have a permit from the San Francisco Municipal Transportation Agency (SFMTA) and is not allowed to use city bus stops and/or drive on city streets.

At step 440, the transportation assets remaining in the pool can be ranked according to cost criteria (e.g., to minimize the cost of fulfilling the on-demand service such as by minimizing vehicle operation (running) time, minimizing passenger time in transit such as reducing delays based on the passenger's classification, and the like). For example, cost criteria for each transportation asset can include amount of time vehicle is in operation (running), depreciation (e.g., as a function of miles driven), fuel costs, driver time (to limit overtime pay), government fees (e.g., SFMTA charges a fee per stop event in order to load and unload in designated shared Muni zones or commuter shuttle-only white zones), and the like. By way of further non-limiting example, each cost criterion can be weighted (relative to the other cost criteria) to control each criterion's contribution to/influence on the ranking.

Alternatively or additionally, a transportation asset remaining in the pool can fulfill more than one on-demand service requests, which can be referred to as “pooling” (and passengers can be referred to as “pooled” passengers). Another way to view the pooling feature is multiple on-demand service requests can be joined together. In this way, the on-demand service requests joined together can be fulfilled by one transportation asset more efficiently, such as due to more pickups, fewer miles spent off route (e.g., miles driven when not on an active ride (fixed route and/or on demand); can also be referred to as “deadheads” and/or non-billable miles), and the like. In this way, a transportation asset using the pooling feature can have a better ranking (e.g., lower cost) than other transportation assets remaining in the pool, when considered relative to the multiple on-demand service requests fulfilled.

In some embodiments, a passenger with an on-demand service request fulfilled using the pooling feature (pooled passenger) may experience a longer time in transit (e.g., delay). Purely for illustration, one transportation asset fulfills on-demand service requests from passenger 1 and passenger 2. Passenger 1 gets picked up at location A (of locations 110_{1,1}-110_{X,Y} in FIG. 1) with an on-demand service request to go to location C (of locations 110_{1,1}-110_{X,Y}). Passenger 2 gets picked up at location B (of locations 110_{1,1}-110_{X,Y}) with an on-demand service request to go to location C. Passenger 1 can experience a longer transit time (e.g., delay) than if the transportation asset went directly from location A to location C. Alternatively, passenger 2 can experience a longer transit time (e.g., delay) than if the transportation asset went directly from location B to location C.

Similar to passenger classification described above in relation to fixed-route service in step 430, on-demand passengers can be classified (e.g., regular/normal to very important person (VIP)). Each classification can have different delay parameters that can be set at the start (pickup) and end (drop-off) locations (of locations 110_{1,1}-110_{X,Y} in FIG. 1). By way of non-limiting example, a regular/normal passenger can have a delay time at a start (pickup) location of 10 minutes and a VIP passenger can have a delay time at a start (pickup) location of 3 minutes. In this example, if the start location estimated time of arrival (ETA) assigned to a regular/normal passenger is 9:00 AM, pooled VIP passengers will be picked up and will delay a regular/normal passenger's pickup if the delay does not extend past 9:10 AM (10 minute pickup location delay for regular/normal passengers). End (drop-off) locations can alternatively or additionally have different delay parameters for each classification. According to various embodiments, start (pickup) and/or end (drop-off) locations can be adjusted (tuned) in real time (on the fly) by data center 230 and/or dispatch 240 (FIG. 2) to improve service efficiency (e.g., reduce costs) and/or passenger experience (e.g., reduce delay time). In this way, transportation assets' respective ranking can change.

At step 450, a transportation asset can be selected from the pool and dispatched/assigned to the on-demand service request. For example, the transportation asset can be selected from the pool based on ranking, such as a higher ranking (when a higher ranking is more cost effective than a lower ranking) or a lower ranking (when a lower ranking is more cost effective than a higher ranking). In various embodiments, fulfilling the on-demand service request can include (one or more of): the transportation asset picking up a passenger from a pick-up location (e.g., location 110_{A} in FIG. 2) at a pick-up time, transporting the passenger, and droping off the passenger at a drop off location (e.g., location 110_{B}) at a drop-off time.

Alternatively or additionally, an on-demand service request can be re-assigned. For example, an asset can be dispatched to fulfill an on-demand service request (earlier iteration of step 450). However, data center 230 and/or dispatch 240 (FIG. 2) have real-time location information of the asset and determine that the asset will miss the pick-time by a pre-determined margin (e.g., due to traffic arising from a random car accident). Data center 230 and/or dispatch 240 can in real-time re-assign the on-demand request to another asset.

Alternatively or additionally, an on-demand service request can be assigned to another transportation service provider. For example, when none of the transportation assets can logistically fulfill the on-demand service request (e.g., none can satisfy the constraints) or can cost-effectively fulfill the on-demand service request (e.g., sending a large bus to transport just one passenger can be impractical), the on-demand service request can be referred to a ride hailing service.

FIG. 5 illustrates an exemplary computer system 500 that may be used to implement some embodiments of the present invention. The computer system 500 in FIG. 5 may be implemented in the contexts of the likes of computing systems, networks, servers, or combinations thereof. The computer system 500 in FIG. 5 includes one or more processor unit(s) 510 and main memory 520. Main memory 520 stores, in part, instructions and data for execution by processor unit(s) 510. Main memory 520 stores the executable code when in operation, in this example. The computer system 500 in FIG. 5 further includes a mass data storage 530, portable storage device 540, output devices 550, user input devices 560, a graphics display system 570, and peripheral device(s) 580.

The components shown in FIG. 5 are depicted as being connected via a single bus 590. The components may be connected through one or more data transport means. Processor unit(s) 510 and main memory 520 are connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit(s) 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 in FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral device(s) 580 may include any type of computer support device to add additional functionality to the computer system.

Some of the components provided in the computer system 500 in FIG. 5 can be those typically found in computer systems that may be suitable for use with embodiments of the present disclosure and are intended to represent a broad category of such computer components. Thus, the computer system 500 in FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 500 may be implemented as a cloud-based computing environment, such as a virtual machine operating within a computing cloud. In other embodiments, the computing system 500 may itself include a cloud-based computing environment, where the functionalities of the computing system 500 are executed in a distributed fashion. Thus, the computing system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 500, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical, magnetic, and solid-state disks, such as a fixed disk. Volatile media include dynamic memory, such as system random-access memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a programmable read-only memory (PROM), an erasable programmable read-only memory (EPROM), an electrically erasable programmable read-only memory (EEPROM), a Flash memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

1. A computer-implemented method for fulfilling an on-demand transportation service request, the method comprising:
receiving, by a processor, an on-demand service request, the on-demand service request including at least one of a variable pick-up time, variable pick-up location, variable drop-off location, and variable drop-off time;
building, by the processor, on a map of a geographical region associated with the variable pick-up location, a first geofence characterized by one of a first circle or a first polygon enclosing the variable pick-up location;
building, by the processor, on the map, a second geofence characterized by one of a second circle or a second polygon enclosing the variable drop-off location;
getting, by the processor, a pool of transportation assets based at least in part on the map, the transportation assets including at least one of a bus, van, mini-van, car, sport utility vehicle, and truck;
removing, by the processor, at least one transportation asset from the pool of transportation assets, the removing the at least one transportation asset including:
selecting, from the pool of transportation assets, a first transportation asset associated with a fixed-route service, the fixed-route service including predefined pick-up and drop-off locations, the selecting being based on determining that at least a portion of the predefined pick-up and drop-off locations of the first transportation asset are positioned within the first geofence and the second geofence on the map; and
withdrawing the first transportation asset from the pool of transportation assets when a delay to a scheduled pick-up time for the fixed-route service of the first transportation asset will exceed a predetermined threshold, the delay arising from hypothetically using the first transportation asset to fulfill the on-demand service request;
ranking, by the processor, remaining transportation assets in the pool of transportation assets using weighted cost criteria, the weighted cost criteria including at least one of depreciation of a transportation asset, fuel cost of the transportation asset, driver time for a driver associated with the transportation asset, and government fees;
selecting, by the processor, a second transportation asset from the pool of transportation assets using the ranking;
dispatching, by the processor, the second transportation asset to fulfill the on-demand service request;
determining, by the processor, that the second transportation asset will be late in the first geofence for the variable pick-up time of the on-demand service request based at least in part on location information received by the processor from the second transportation asset, the location information including a location continuously determined by a global positioning system unit of the second transportation asset at predetermined times;
selecting, by the processor, a third transportation asset from the pool of transportation assets based at least in part on the ranking; and
dispatching, by the processor, the third transportation asset to the variable pick-up location to fulfill the on-demand service request.

2. The computer-implemented method of claim 1, wherein the removing the at least one transportation asset further includes:
deleting a fourth transportation asset from the pool of transportation assets when fulfilling the on-demand service request will cause an operator associated with the fourth transportation asset to exceed a maximum number of work hours.

3. The computer-implemented method of claim 2, wherein the removing the at least one transportation asset further includes:
expunging a fifth transportation asset from the pool of transportation assets when fulfilling the on-demand service request will cause a vehicle associated with the fifth transportation asset to run out of fuel, the fuel being at least one of battery power and compressed natural gas.

4. The computer-implemented method of claim 3, wherein the removing the at least one transportation asset further includes:
taking away a sixth transportation asset from the pool of transportation assets when the sixth transportation asset does not include equipment to fulfill the on-demand service request, the equipment including a lavatory.

5. The computer-implemented method of claim 4, wherein the equipment alternatively includes at least one of a lift, ramp, and securement device.

6. The computer-implemented method of claim 5, wherein the removing the at least one transportation asset further includes:
deleting a seventh transportation asset from the pool of transportation assets when an operator associated with the seventh transportation asset does not have at least one of a license and certification to fulfill the on-demand service request.

7. The computer-implemented method of claim 6, wherein the removing the at least one transportation asset further includes:
deleting an eighth transportation asset from the pool of transportation assets when a vehicle associated with the eighth transportation asset does not have at least one of a license and certification to fulfill the on-demand service request.

8. The computer-implemented method of claim 7, wherein the on-demand service request is received at least twenty-four hours before the variable pick-up time.

9. The computer-implemented method of claim 8, wherein:
the transportation assets further include a self-driving vehicle.

10. The computer-implemented method of claim 8, wherein:
the transportation assets are operated by one company; and
the location information is determined using a mobile device associated with the second transportation asset, the mobile device including a mobile operating system, the mobile operating system including at least one of Apple iOS and Google Android.

11. A system for fulfilling an on-demand transportation service request, the system comprising:
at least one processor; and
at least one memory communicatively coupled to the at least one processor, the at least one memory storing instructions executable by the at least one processor to perform a method comprising:
receiving an on-demand service request, the on-demand service request including at least one of a variable pick-up time, variable pick-up location, variable drop-off location, and variable drop-off time;
building, on a map of a geographical region associated with the variable pick-up location, a first geofence characterized by one of a first circle or a first polygon enclosing the variable pick-up location;
building, on the map, a second geofence characterized by one of a second circle or a second polygon enclosing the variable drop-off location;
getting a pool of transportation assets based at least in part on the map, the transportation assets including at least one of a bus, van, mini-van, car, sport utility vehicle, and truck;
removing at least one transportation asset from the pool of transportation assets, the removing the at least one transportation asset including:
selecting, from the pool of transportation assets, a first transportation asset associated with a fixed-route service, the fixed-route service including predefined pick-up and drop-off locations, the selection being based on determining that at least a portion of the predefined pick-up and drop-off locations of the first transportation asset are positioned within the first geofence and the second geofence on the map; and
withdrawing the first transportation asset from the pool of transportation assets when a delay to a scheduled pick-up time for a fixed-route service of the first transportation asset will exceed a predetermined threshold, the delay arising from hypothetically using the first transportation asset to fulfill the on-demand service request;
ranking remaining transportation assets in the pool of transportation assets using weighted cost criteria, the weighted cost criteria including at least one of depreciation of a transportation asset, fuel cost of the transportation asset, driver time for a driver associated with the transportation asset, and government fees;
selecting a second transportation asset from the pool of transportation assets using the ranking;
dispatching the second transportation asset to fulfill the on-demand service request;
determining that the second transportation asset will be late in the first geofence for the variable pick-up time of the on-demand service request based at least in part on location information received from the second transportation asset, the location information including a location continuously determined by a global positioning system unit of the second transportation asset at predetermined times;
selecting a third transportation asset from the pool of transportation assets based at least in part on the ranking; and
dispatching the third transportation asset to the variable pick-up location to fulfill the on-demand service request.

12. The system of claim 11, wherein the removing the at least one transportation asset further includes:
deleting a fourth transportation asset from the pool of transportation assets when fulfilling the on-demand service request will cause an operator associated with the fourth transportation asset to exceed a maximum number of work hours.

13. The system of claim 12, wherein the removing the at least one transportation asset further includes:
expunging a fifth transportation asset from the pool of transportation assets when fulfilling the on-demand service request will cause a vehicle associated with the fifth transportation asset to run out of fuel, the fuel being at least one of battery power and compressed natural gas.

14. The system of claim 13, wherein the removing the at least one transportation asset further includes:
taking away a sixth transportation asset from the pool of transportation assets when the sixth transportation asset does not include equipment to fulfill the on-demand service request, the equipment including a lavatory.

15. The system of claim 14, wherein the equipment alternatively includes at least one of a lift, ramp, and securement device.

16. The system of claim 15, wherein the removing the at least one transportation asset further includes:
deleting a seventh transportation asset from the pool of transportation assets when an operator associated with the seventh transportation asset does not have at least one of a license and certification to fulfill the on-demand service request.

17. The system of claim 16, wherein the removing the at least one transportation asset further includes:
deleting an eighth transportation asset from the pool of transportation assets when a vehicle associated with the eighth transportation asset does not have at least one of a license and certification to fulfill the on-demand service request.

18. The system of claim 17, wherein the on-demand service request is received at least twenty-four hours before the variable pick-up time.

19. The system of claim 18, wherein the transportation assets further include a self-driving vehicle.

20. A system for fulfilling an on-demand service request, the system comprising:
means for receiving an on-demand service request, the on-demand service request including at least one of a variable pick-up time, variable pick-up location, variable drop-off location, and variable drop-off time;
means for
building, on a map of a geographical region associated with the variable pick-up location, a first geofence characterized by one of a first circle or a first polygon enclosing the variable pick-up location
means for building, on the map, a second geofence characterized by one of a second circle or a second polygon enclosing the variable drop-off location;
means for getting a pool of transportation assets based at least in part on the map with the built first geofence and the second geofence, the transportation assets including at least one of a bus, van, mini-van, car, sport utility vehicle, and truck;
means for removing at least one transportation asset from the pool of transportation assets, the removing the at least one transportation asset including:
selecting, from the pool of transportation assets, a first transportation asset associated with a fixed-route service, the fixed-route service including predefined pick-up and drop-off locations, the selection being based on determining that at least a portion of the predefined pick-up and drop-off locations of the first transportation asset are positioned within the first geofence and the second geofence on the map; and
withdrawing a first transportation asset from the pool of transportation assets when a delay to a scheduled pick-up time for a fixed-route service of the first transportation asset will exceed a predetermined threshold, the delay arising from hypothetically using the first transportation asset to fulfill the on-demand service request;
means for ranking remaining transportation assets in the pool of transportation assets using weighted cost criteria, the weighted cost criteria including at least one of depreciation of a transportation asset, fuel cost of the transportation asset, driver time for a driver associated with the transportation asset, and government fees;
means for selecting a second transportation asset from the pool of transportation assets using the ranking;
means for dispatching the second transportation asset to fulfill the on-demand service request;
means for determining that the second transportation asset will be late in the first geofence for the variable pick-up time of the on-demand service request based at least in part on location information received from the second transportation asset, the location information including a location continuously determined by a global positioning system unit of the second transportation asset at predetermined times;
means for selecting a third transportation asset from the pool of transportation assets based at least in part on the ranking; and
means for dispatching the third transportation asset to the variable pick-up location to fulfill the on-demand service request.
